(19) United States
(12) Patent Application Publication
(10) Pub. No.: US 2006/0238289 A1
(43) Pub. Date: Oct. 26, 2006

(54) Variable resistance cord connector

(75) Inventors: George Marmaropoulos, Yorktown Heights, NY (US); Vu Giang, New York, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/558,730

(22) PCT Filed: Jun. 1, 2004
(86) PCT No.: PCT/IB04/50817

§ 371 Date: Nov. 29, 2005

Related U.S. Application Data
(60) Provisional application No. 60/475,707, filed on Jun. 4, 2003.

(51) Int. Cl. G01B 7/16

(52) U.S. Cl. 338/6

(57) ABSTRACT

A wearable garment having a pair of conductive cords incorporates an easily operated manual interconnect device, which enables a user wearing the garment to operate different interconnect devices requiring different input voltage levels using a common power source. Through a releasable locking action by the user, the electronic device is electrically coupled to the conductive cords, which is in turn coupled to a power source. By merely coupling an external electronic device to the conductive cords, an appropriate input voltage level of the connected device is detected based on the amount of tension experienced by the conductive cords.

This invention relates to an interconnect system intended to detect the type of electronic device connected to a fabric electric circuit embedded in a garment. More specifically, the invention relates to an interconnect system having a pair of variable resistance cords incorporated into the garment which changes the operation voltage of the connected electronic device according to the change in the resistance in the cords.

In wearable electronic applications, it is desirable to have electrical interconnect solutions that are adjusted to the requirements of the soft characteristics of the garments. In addition, it is desirable to have one power source that can serve a variety of wearable electronic devices, which operate on different voltages, depending on which device is connected to the garment each time. However, to the best of the current inventors' knowledge, the prior art devices in wearable electronic applications are not capable of detecting the type of electronic devices connected to the garment and adjusting the voltage accordingly.

Therefore, the present invention relates to a garment electrical connector that can automatically detect the type of device connected to the garment and adjust the power or interface accordingly. In addition, the present invention facilitates manufacture of such connectors as close as possible to the manufacturing techniques used in the garment industry for widespread acceptance within the garment manufacturing industry.

The present invention discloses a wearable garment with an electrical interconnect system, which includes at least one pair of conductive cords mounted to the body of the garment. An external electronic device having at least one pair of grooves is detachably coupled to the conductive cords of the garment for coupling a power source. The conductive cords are electrically coupled to a fabric circuit integrated in the garment material.

According to one aspect of the invention, a garment of desired form and function can be constructed in a conventional manner using readily available fabrics and materials, and the electrical interconnect system can be positioned advantageously that permits easy manual activation by a person.

According to another aspect of the invention, the interconnect system includes a pair of parallel conductive cords releasably coupled to an external electronic device having at least two grooves. The grooves dock into the pair of parallel conductive cords that in turn are connected to a fabric circuit or network on a garment. The cords are elastic enough to provide the necessary tension to secure the device in place mechanically and enable a positive electrical connection to a power source located at another place on the garment. In the embodiment, a change in the resistance of the cords is detected by an electronic circuit which in turn changes the operational voltage of the connected device to match to the voltage associated with the distance between the grooves of the connected device. In an alternate embodiment, the interconnect system also can be used for simpler applications where only connection is needed, without the automatic detection capability.

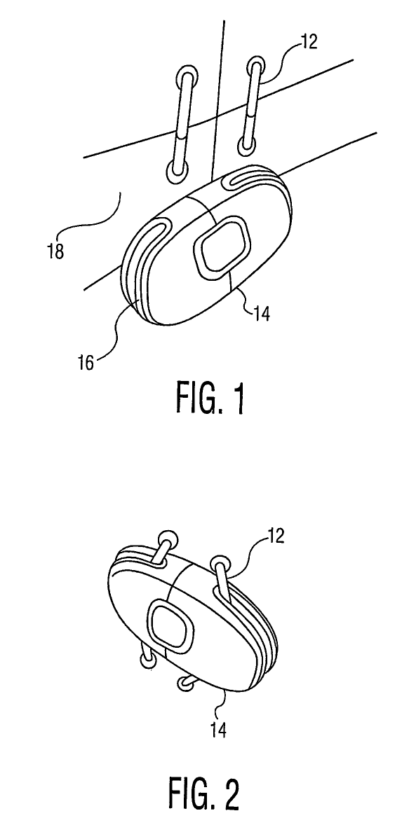

FIG. 1 illustrates an embodiment of an electrical interconnect system in accordance with this invention

FIG. 2 illustrates the electrical interconnect system of FIG. 1 during operation in accordance with the embodiment of this invention.

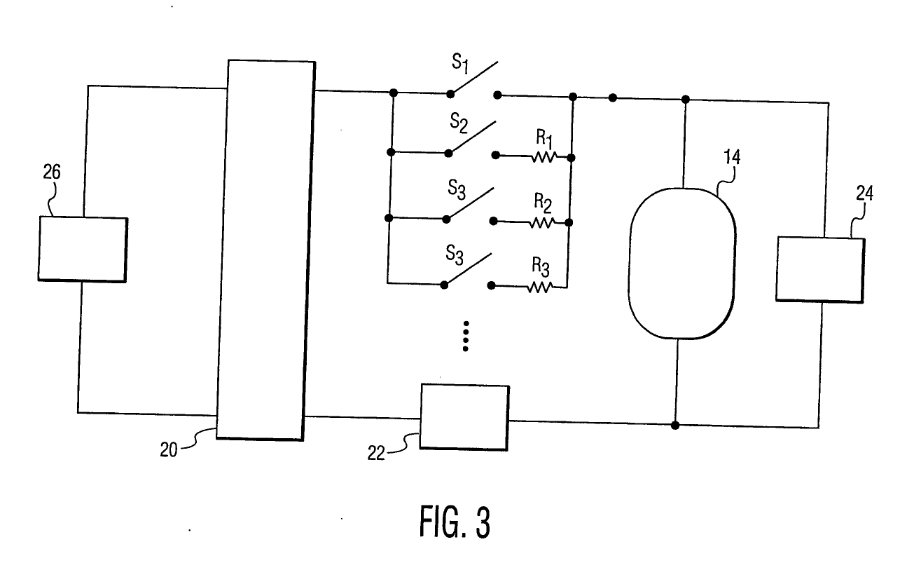

FIG. 3 illustrates an equivalent circuit diagram of the electrical interconnect system of FIG. 1 in accordance with the embodiment of this invention.

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

Referring to FIG. 1, an electrical interconnect device 10 in accordance with the present invention includes a pair of cords 12 integrated on a wearable garment 18. As shown, the interconnect device 10 comprises a pair of parallel, variable-resistance conductive cords 12 extending from the fabric of the garment 18, with the cords 12 being coupled to a fabric circuit or power source provided in the garment 18.

In operation, a wearer can readily engage the electronic device 14, such as a cell phone, radio, pager, (PS device, personal communication assistant, external heart monitoring device, or other signal transmitter or duplex interactive system, carried anywhere on the person of the wearer of the band, by merely docketing it to the grooves 16. Although an elliptical-shaped electronic device 14 is shown for illustrative purposes, it is to be understood that the present invention can support other shapes. Thus, the shape of the electronic device 14 in the drawings should not impose limitations on the scope of the invention.

In the embodiment illustrated in FIG. 1, the garment 18 may be in the form of a conventional sleeveless top shirt or a long-sleeved or short-sleeved, vest or jacket, for example. In addition, the materials of garment 18 may be either natural or synthetic, and the fabric created from such materials can be either woven or sheet-formed in any well-known manner.

Referring to FIG. 2, the pair of elastic cords 12 that allows the connection of a power supply is electrically coupled to the conductive grooves 16 of the external electronic device 14 for transmitting signal or power. As shown, the cords 12 are elastic enough to provide adequate tension to hold the electronic device 14 in place while providing a positive electrical connection to a power source located at a predetermined place on the garment.

Note that the distance between the grooves 16 of the electronic device 14 will vary depending on the size of the interconnected device. Accordingly, the distance between the grooves 16 is related to the voltage that each device operates. For example, if the distance between the grooves is the same, then the operational voltage must be the same. Another device may cause the cords 12 to stretch differently, thus requiring a different operational voltage. Therefore, in the embodiment, a change in the resistance of the cords 12 is utilized to detect different electronic devices docketed between the grooves 16, and then the detected resistance is used to vary the operational voltage applied to the electronic device 14 accordingly.

FIG. 3 depicts a representative circuit diagram of the electrical interconnect device in accordance with the present invention. As shown, the electrical interconnect device 10 comprises a bridge switch 20 having a series of switches (S1-Sn) and resistors (R1-Rn), a CPU or controller 22, a tension sensor 24, and a battery power source 26. It will be apparent to those skilled in the art that other hardware configurations of the planner board from the one shown can be used successfully. Further, various functional operations associated with the electric interconnect device 10 may be implemented in whole or in part in one or more software programs/signal processing routines stored in a program memory and executed by a processor. The program memory may represent, e.g., disk-based optical or magnetic storage units, electronic memories, as well as portions or combinations of these and other memory devices.

In operation, the conductive area 16 of the electronic device 14 is electrically mounted to the cords 12, which is in turn electrically coupled to a conductive track of a fabric circuit integrated in the garment 18. At this time, the tension sensor 24 is activated to determine the amount of stretch experienced by the elastic cords 12. Note that the cords 12 are stretched according to the distance between the grooves 16. The change in the resistance of the cords 12 is detected by the tension sensor 24 and this result is sent to controller 22, which in turn changes the operational voltage of the interconnect device 10 to correspond to the voltage associated with the distance between the grooves 16 of the connected electronic device 14. To this end, a memory (not shown) may be provided with a look-up table containing different operational voltage levels that match the various resistance levels experienced by the cords 12.

Upon determining the appropriate operation voltage level required by the connected electronic device 14, the controller 22 selectively activates switches S1, S2, and 83, via the bridge switch 20, so the right amount of voltage can be delivered to the electronic device 14.

While the preferred embodiments of the present invention have been illustrated and described, it will be understood by those skilled in the art that various changes and modifications can be made, and equivalents may be substituted for elements thereof without departing from the true scope of the present invention. Therefore, it is intended that the present invention not be limited to the particular embodiment disclosed as the best mode contemplated for carrying out the present invention, but that the present invention include all embodiments falling within the scope of the appended claims.

1. An interconnect apparatus comprising:
at least one interconnect element having at least one pair of electrically conductive cords (12);
a sensor (24) for detecting an amount of tension applied to said conductive cords (12) when said conductive cords (12) are releasably coupled to an electronic device (14); and,
a controller (26) for selectively varying an operational voltage applied to said electronic device (14) based on said detected tension.

2. The interconnect apparatus of claim 1, further comprising a power source (26) to deliver the operational voltage to said external electronic device (14).

3. The interconnect apparatus of claim 1, wherein said interconnect apparatus is coupled to a fabric circuit integrated in a garment (18).

4. The interconnect apparatus of claim 1, wherein said conductive cords (12) are mounted on the outer surface of a garment (18) for engaging and supporting said electronic device (14) to transmit electrical signals.

5. The interconnect apparatus of claim 1, wherein said electronic device (14) comprises at least one pair of grooves (16) at both ends thereof for electrically and physically coupling said conductive cords (12).

6. A wearable garment comprising the interconnect apparatus of claim 1.

7. A wearable garment comprising the interconnect apparatus of claim 2.

8. A wearable garment comprising the interconnect apparatus of claim 3.

9. A wearable garment comprising the interconnect apparatus of claim 4.

10. A wearable garment comprising the interconnect apparatus of claim 5.

11. A method for controlling an operational voltage of an electronic device (4), the method comprising the steps of:
providing at least one power source (26) in a wearable garment (18);
mounting an interconnect device having at least one pair of electrically conductive cords (12) to said wearable garment (18) to serve as a coupling to said power source (26);
releasably coupling an electronic device (14) to said pair of conductive cords (12); and,
determining an appropriate operation voltage for said electronic device (14) based on said detected tension applied to said conductive cords (12) when being electrically coupled to said electronic device (14).

12. The method of claim 11, further comprising the step of dressing a person in said wearable garment (18).
